(19) United States
(12) Patent Application Publication
(10) Pub. No.: US 2009/0303922 A1
(43) Pub. Date: Dec. 10, 2009

(54) METHOD AND APPARATUS FOR COMMUNICATING A PLURALITY OF PACKETS IN A COMMUNICATION NETWORK

(76) Inventors: Rehan Jalil, San Jose, CA (US); Mustafa Ergen, Oakland, CA (US)

Correspondence Address: Global IP Services, PLLC, 198 F, 27th Cross, 3rd Block, Jayanagar, Bangalore, Karnataka, 560011, IN

(21) Appl. No.: 12/133,371

(22) Filed: Jun. 5, 2008

(51) Int. Cl. H04Q 7/00

(52) U.S. Cl. 370/328

(57) ABSTRACT

A method and apparatus for communicating a plurality of packets in a communication network is provided. The method includes suppressing one or more portions of the plurality of packets based on a suppression rule in a central controller. Thereafter, each packet is transmitted from the central controller to one or more Mobile Stations (MSs) through one or more Base Stations (BSs).

### FIELD OF THE INVENTION

Generally, the invention relates to a communication network. More specifically, the invention relates to a method and apparatus for communicating a plurality of packets in a communication network. Examples of the communication network may include, but are not limited to, Worldwide Interoperability for Microwave Access (WiMAX) communication network, 3rd Generation Partnership Project (3GPP) network including 3GPP Long Term Evolution (LTE) network, 3rd Generation Partnership Project 2 (3GPP2) network including 3GPP2 Ultra Mobile Broadband (UMB) network, as well as Wireless Fidelity (WiFi) network, and any variant of Orthogonal Frequency Division Multiple Access (OFDMA) communication network having a backhaul link.

### BACKGROUND OF THE INVENTION

In a communication network, a controller communicates with one or more Base Stations (BSs) for providing various communication services. A communication service is provided by transmitting a plurality of packets. The communication services may include, but are not limited to, video distribution, vehicle tracking, e-learning, file sharing, web browsing, and weather monitoring. A BS further provides these communication services to a plurality of Mobile Stations (MSs) by transmitting the plurality of packets to the plurality of MSs.

Generally, one or more portions in the headers of a packet are repeated over the plurality of packets. Therefore, transmitting one or more portions, which are repeated over the plurality of packets, for each packet leads to unwanted consumption of network bandwidth. In order to reduce this bandwidth requirement, a BS uses a processor to remove one or more portions, which are repeated over the headers of the plurality of packets, from each packet before transmitting to an MS. However, this increases the processing load of the BS. Additionally, the cost of the BS also increases for implementing the processor inside the BS.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram showing a WiMAX communication network (that is exemplary) in which various embodiments of the invention may function.

FIG. 2 is a flowchart of a method of communicating a plurality of packets in a communication network, in accordance with an embodiment of the invention.

FIG. 3 a flowchart of a method of processing a plurality of packets in a communication network, in accordance with an embodiment of the invention.

FIG. 4 is a block diagram of a central controller in a communication network, in accordance with an embodiment of the invention.

FIG. 5 is a block diagram of a Base Station, in accordance with an exemplary embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to communicating a plurality of packets in a communication network. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide methods and apparatus for communicating a plurality of packets in a communication network. Examples of the communication network may include, but are not limited to, Worldwide Interoperability for Microwave Access (WiMAX) communication network, 3rd Generation Partnership Project (3GPP) network including 3GPP Long Term Evolution (LTE) network, 3rd Generation Partnership Project 2 (3GPP2) network including 3GPP2 Ultra Mobile Broadband (UMB) network, Wireless Fidelity (WiFi) network, and any variant of Orthogonal Frequency Division Multiple Access (OFDMA) communication network having a backhaul link.

In the communication network, a central controller is connected to one or more Base Stations (BSs) for providing one or more communication services. A communication service is provided by transmitting a plurality of packets to the BSs. One or more portions of each packet are suppressed in the central controller based on a suppression rule. Thereafter, a BS transmits the plurality of packets to a plurality of Mobile Stations (MSs).

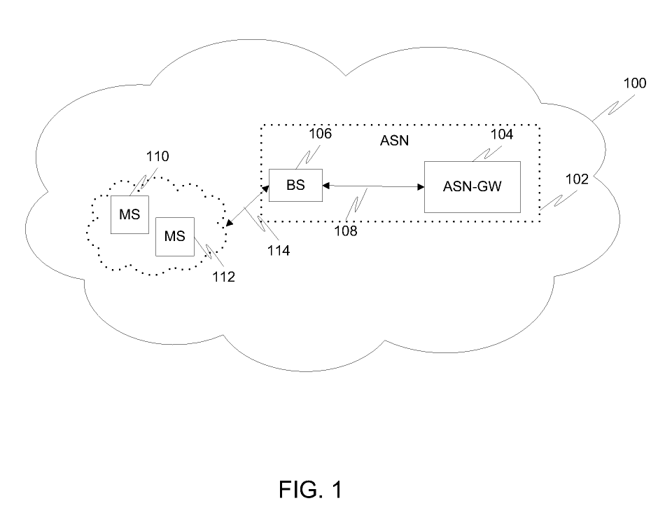

FIG. 1 is block diagram showing a WiMAX communication network 100 (that is exemplary) in which various embodiments of the invention may function. WiMAX communication network 100 includes an Access Service Network (ASN) 102. It will be apparent to a person skilled in the art that WiMAX communication network 100 may include more than one ASN. ASN 102 includes an ASN-Gateway (GW) 104 and a BS 106. ASN-GW 104 communicates with BS 106 through an R6 link 108. R6 link 108 is a backhaul link and is used for providing Internet Protocol (IP) connectivity to BS 106. It will be apparent to a person skilled in the art that ASN 102 may include more than one ASN-GW and each ASN-GW may communicate with more than one BS. Additionally, an ASN-GW may use a plurality of R6 links for communicating with more than one BS.

Further, BS 106 provides communication services to Mobile Station (MS) 110 and MS 112 through an RI link 114. Examples of a MS may include but are not limited to a laptop, a computer, a Personal Digital Assistant (PDA), and a hand-held device. A subscriber uses a MS to avail communication services over wireless connectivity provided by a corresponding BS.

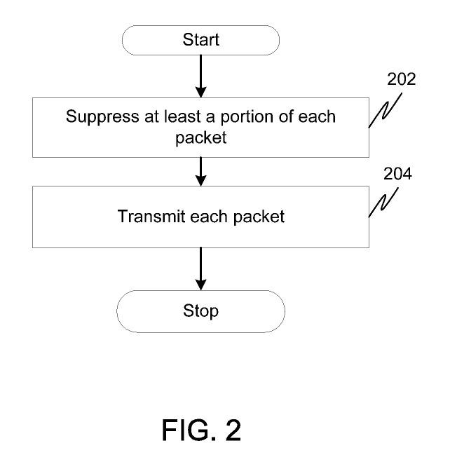

FIG. 2 is a flowchart of a method of communicating a plurality of packets in a communication network, in accordance with an embodiment of the invention. The communication network may be WiMAX communication network 100. Alternatively, the communication network may be an LTE network or a UMB network. A central controller is connected to one or more BSs for providing various communication services. The central controller may be ASN-GW 104 in WiMAX communication network 100. Alternatively, the central controller may be a Serving Gateway (SGW) or Packet Data Network Gateway (PDN-GW) in the LTE network. Instead, the central controller may be an Access Gateway (AGW) in the UMB network.

A communication service is provided by transmitting the plurality of packets from the central controller to one or more BSs. One or more portions of the plurality of packets may be repeated over the plurality of packets. Transmission of one or more portions of the packet that are repeated may impose burden on the communication network. Therefore, in order to reduce the burden on the communication network, one or more portions of each packet are suppressed based on a suppression rule in the central controller, at step 202. In an embodiment of the invention, one or more portions in payload headers of the plurality of packets are repeated over the plurality of packets. Therefore, in order to reduce the bandwidth requirements of the communication network, one or more portions of the payload headers that are repeated are suppressed based on a Payload Header Suppression (PHS) rule by the central controller. The PHS rule is used to select a PHS Index (PHSI). Thereafter, based on the PHSI index, one or more bytes of a Payload Header Suppression Field (PHSF) in each packet are removed by the central controller. Finally, the PHS index is appended to the payload header of each packet.

In another embodiment of the invention, one or more portions of each packet are suppressed based on a RObust Header Compression (ROHC) rule. A context identifier is used for suppressing one or more portions of each packet based on the ROHC rule. The context identifier describes about static fields, dynamic fields and their change pattern in the header of each packet.

Alternatively, one or more portions of each packet may be suppressed based on an Enhanced Compressed Real-Time Transport Protocol (ECRTP) rule. In this suppression scheme, information about the changes in a header of a packet and a header of a preceding packet is used for suppressing one or more portions of the header of the packet.

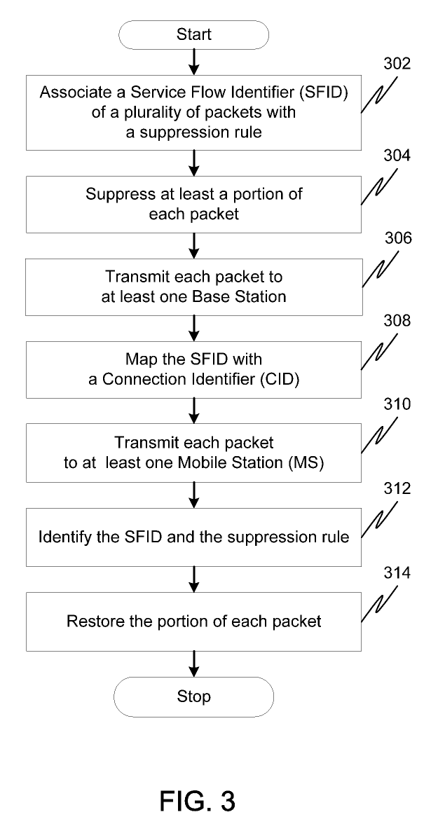

Thereafter, each packet is transmitted from the central controller to one or more MSs through one or more Base Stations BSs at 204. Finally, one or more portions of the packets, which are suppressed at the central controller, are restored at the MSs. This is further explained in detail in conjunction with FIG. 3.

FIG. 3 a flowchart of a method of processing a plurality of packets in a communication network, in accordance with an embodiment of the invention. A central controller associates a Service Flow Identifier (SFID) of the plurality of packets with a suppression rule by, at step 302. A SFID is a 32-bit value, which assigns a service flow of packets to a MS and a BS. Additionally, the SFID defines the Quality of Service (QoS) parameters of the service flow of the packets. The suppression rule associated with the SFID may be a PHS rule. Alternatively, the suppression rule may be one of a ROHC rule and an ECRTP rule.

At 304, one or more portions of each packet are suppressed based on the suppression rule. This has been explained in conjunction with FIG. 2. Thereafter, each packet is transmitted from the central controller to one or more MSs at 306.

At 308, the SFID of the plurality of packets is mapped with a Connection Identifier (CID) by the BS. A CID is a 16-bit value that identifies a connection between a BS and one or more MSs. Thereafter, at 310, each packet is transmitted to one or more MSs from the BS. A MS receives the plurality of packets transmitted from a BS. At 312, the MS uses the CID to identify the SFID and the suppression rule corresponding to the plurality of packets. More particularly, the SFID of the plurality of packets is retrieved using the CID by the MS. Thereafter, from the SFID, the suppression rule applied to the plurality of packets is identified. Finally, at 314, one or more portions of the plurality of packets, which are suppressed at the central controller, are restored at the MS using the suppression rule corresponding to the plurality of packets. In an embodiment of the invention, one or more portions of the packet are restored using the PHS index.

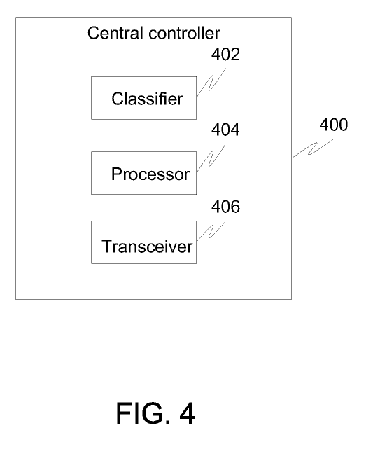

FIG. 4 is a block diagram of a central controller 400 in a communication network, in accordance with an embodiment of the invention. The communication network may be a WiMAX communication network and central controller 400 may be an ASN-GW. Central controller 400 includes a classifier 402, a processor 404, and a transceiver 406.

Classifier 402 associates a SFID of a plurality of packets with a suppression rule. The SFID is a 32-bit value, which assigns a service flow of packets to a MS and a BS. It defines the QoS parameters of the service flow of the packets. The suppression rule may be a PHS rule. Alternatively, the suppression rule may be one of a ROHC rule and an ECRTP rule.

One or more portions of the plurality of packets may remain unchanged and may be repeated over the plurality of packets. In an embodiment of the invention, one or more portions in headers of the plurality of packets may be repeated over the plurality of packets. Processor 404 suppresses one or more portions of each packet, which are repeated over the plurality of packets. This has been explained in detail, in conjunction with FIG. 2.

After suppressing one or more portions of each packet, transceiver 406 transmits each packet to one or more MSs through one or more BSs. This has been explained already in detail, in conjunction with FIG. 3.

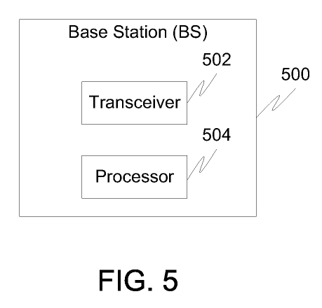

FIG. 5 is a block diagram of a Base Station 500, in accordance with an embodiment of the invention. BS 500 includes a transceiver 502 that receives a plurality of suppressed packets from central controller 400. A suppressed packet is generated by suppressing one or more portions of a corresponding packet by central controller 400. This has been explained in conjunction with FIG. 2 and FIG. 3. Therefore, BS 500 does not need to do any processing to suppress one or more portions of a packet.

BS 500 further includes a processor 504 for associating a SFID of the plurality of suppressed packets with a CID. The SFID is a 32-bit value, which allocates a service flow of packets to a MS and a BS. It defines the QoS parameters of the service flow of the packets. The CID is a 16-bit value that identifies a connection between the BS and the MS.

Thereafter, transceiver 502 transmits the plurality of suppressed packets to the MS. The MS identifies the SFID using the CID, and from the CID, it identifies the suppression rule corresponding to the suppressed packet. Thereafter, the MS restores one or more portions of the suppressed packet, which are suppressed at the central controller, based on the suppression rule.

Various embodiments of the invention provide a method and apparatus for communicating a plurality of packets in a communication network. One or more portions of the plurality of packets that are repeated over the plurality of packets are suppressed at a central controller rather than at a BS. Therefore, processing burden on the BS is reduced. Consequently, the need for using heavy and high-cost BS with complex processor is eliminated. Simple and economic BSs with less processing function can be implemented. As a result, several BSs can be deployed at less cost, which increases signal coverage and strength. Therefore, overall communication quality is improved.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of communicating a plurality of packets in a communication network, the method comprising:
suppressing at least a portion of each packet based on a suppression rule in a central controller; and
transmitting each packet from the central controller to at least one Mobile Station (MS) through at least one Base Station (BS).

2. The method of claim 1 further comprising:
associating a Service Flow Identifier (SFID) of the plurality of packets with the suppression rule by the central controller; and
mapping the SFID with a Connection Identifier (CID) by a BS, the CID corresponds to a link between the BS and a MS.

3. The method of claim 2 further comprising:
identifying the SFID and the suppression rule using the CID; and
restoring a portion of a packet based on the suppression rule corresponding to the packet.

4. The method of claim 1, wherein the communication network is one of a Worldwide Interoperability for Microwave Access (WiMAX) communication network, 3rd Generation Partnership Project (3GPP) Long Term Evolution (LTE) network, 3rd Generation Partnership Project 2 (3GPP2) Ultra Mobile Broadband (UMB) network, Wireless Fidelity (WiFi) network, and Orthogonal Frequency Division Multiple Access (OFDMA) communication network having a backhaul link.

5. The method of claim 1, wherein the central controller is an Access Service Network-Gateway (ASN-GW).

6. The method of claim 1, wherein with the suppression rule is a Payload Header Suppression (PHS) rule.

7. The method of claim 6, wherein suppressing comprises:
removing at least one byte of a Payload Header Suppression Field (PHSF) in a packet based on a PHS Index (PHSI), the PHSI corresponding to the PHS rule; and
appending the PHSI to a header of the packet.

8. The method of claim 1, wherein suppressing is performed based on a RObust Header Compression (ROHC) rule.

9. The method of claim 1, wherein suppressing is performed based on an Enhanced Compressed Real-Time Transport Protocol (ECRTP) rule.

10. A central controller in a communication network, the central controller comprising:
a processor configured to suppress at least a portion of each of a plurality of packets based on a suppression rule; and
a transceiver configured to transmit each packet to at least one Mobile Station (MS) through at least one Base Station (BS).

11. The central controller of claim 10 further comprising a classifier configured to associate a Service Flow Identifier (SFID) of the plurality of packets with the suppression rule.

12. The central controller of claim 10, wherein the central controller is an Access Service Network-Gateway (ASN-GW).

13. The central controller of claim 10, wherein the suppression rule is a Payload Header Suppression (PHS) rule.

14. The central controller of claim 10, wherein the suppression rule is a RObust Header Compression (ROHC) rule.

15. The central controller of claim 10, wherein the suppression rule is an Enhanced Compressed Real-Time Transport Protocol (ECRTP) rule.

16. A Base Station (BS) in a communication network, the BS comprising:
a transceiver configured to receive a plurality of suppressed packets from a central controller, wherein a suppressed packet is generated by suppressing at least a portion of a corresponding packet; and
a processor configured to associate a Service Flow Identifier (SFID) of the plurality of suppressed packets with a Connection Identifier (CID), wherein the CID corresponds to a link between the BS and a MS.

17. The BS of claim 16, wherein the transceiver is further configured to transmit the plurality of suppressed packets to the MS.

18. The BS of claim 17, wherein the MS is configured to:
identify the SFID and a suppression rule using the CID, wherein the suppression rule is associated with the SFID; and
restore a portion of a suppressed packet based on the suppression rule corresponding to the suppressed packet.
